(19) United States
(12) Patent Application Publication
(10) Pub. No.: US 2014/0278946 A1
(43) Pub. Date: Sep. 18, 2014

(54) ADVERTISEMENT AND ACTUAL BENEFIT DISTRIBUTION IN A GEOCACHING/TREASURE HUNTING ENVIRONMENT

(71) Applicant: CodeGeo, Inc., Vancouver, WA (US)

(72) Inventors: Michael G. Powell, Stayton, OR (US); Bradley R. Bowder, Salem, OR (US); Paul D. Patterson, Vancouver, WA (US); Sarah L. Kolodge, Newberg, OR (US); Donald L. Clifford, Salem, OR (US)

(73) Assignee: CodeGeo, Inc., Vancouver, WA (US)

(21) Appl. No.: 14/213,226

(22) Filed: Mar. 14, 2014

Related U.S. Application Data
(60) Provisional application No. 61/799,584, filed on Mar. 15, 2013.
(60) Provisional application No. 61/798,702, filed on Mar. 15, 2013.
(60) Provisional application No. 61/799,491, filed on Mar. 15, 2013.

(51) Int. Cl. G06Q 30/02

(52) U.S. Cl. CPC G06Q 30/0261; G06Q 30/0248; G06Q 30/0275
USPC 705/14.47

(57) ABSTRACT

An example embodiment includes a method including receiving a seeker inquiry. The method includes communicating coordinates of a geocache in response to the seeker inquiry. The geocache includes a geoseed that is sponsored by an advertiser. The method also includes identifying an actual benefit provided for locating the geoseed. The actual benefit is associated with the advertiser. The method includes receiving a confirmation signal indicating a seeker has located the geocache. The confirmation signal includes verification information specific to the geoseed. The method also includes authenticating the verification information. The method also includes awarding the seeker the actual benefit.

### CROSS REFERENCE TO RELATED PATENT APPLICATIONS

This patent application claims priority to and the benefit of U.S. Provisional Applications Nos. 61/799,584, 61/798,702, and 61/799,491, which are herein incorporated by reference in their entireties.

### FIELD

The embodiments discussed herein are generally related to advertisement and actual benefit distribution in a geocaching/treasure hunting environment.

### BACKGROUND

Geocaching is an outdoor recreational activity in which participants, called seekers, use a global positioning system (GPS) receiver, a mobile device, and other navigational techniques to hide-and-seek containers referred to as “geocaches.” Geocaching is similar to benchmarking, trigpointing, orienteering, treasure-hunting, letterboxing, and waymarking. The geocaches may be hidden anywhere in the world. An example geocache may be a small waterproof container in which a logbook is placed. When the geocache is found, the seeker who finds the geocache writes the date she found the cache in the logbook and signs the logbook. The signature of the seeker may include a real name or a code name the seeker previously established. Larger geocaches such as plastic storage containers or ammunition boxes may contain items which are referred to as geoseeds. The geoseeds can include toys or trinkets.

The geoseeds are traded among seekers. Additionally, some geoseeds are referred to as trackables. The trackable may have a serial number or another distinct marking. The trackables are transported from one geocache to another by the seekers. Geocache websites log the travel and interaction history of the trackables. Seekers may view the travel and the interaction history of the trackables by interacting with the geocache websites. Geocaches are currently placed in over two hundred countries, all seven continents, and on the International Space Station. After nearly thirteen years of activity, there are over 1.9 million active geocaches published on multiple geocache websites.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example embodiment includes a method that includes receiving a seeker inquiry. The method includes communicating coordinates of a geocache in response to the seeker inquiry. The geocache includes a geoseed that is sponsored by an advertiser. The method also includes identifying an actual benefit provided for locating the geoseed. The actual benefit is associated with the advertiser. The method includes receiving a confirmation signal indicating a seeker has located the geocache. The confirmation signal includes verification information specific to the geoseed. The method also includes authenticating the verification information. The method also includes awarding the seeker the actual benefit.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example geocaching/treasure hunting environment (geocaching environment) in which some embodiments may be implemented;

FIG. 2 is a block diagram of a computing device that may be included in the geocaching environment of FIG. 1;

FIG. 3 illustrates an example set of clues that may be used in the geocaching environment of FIG. 1;

FIG. 4 illustrates an example map that may be provided in the geocaching environment of FIG. 1;

FIG. 5 illustrates an example geocache that may be implemented in the geocaching environment of FIG. 1; and

FIGS. 6A-6D are a flow diagram of an example method of awarding an actual benefit in a geocaching environment,

all arranged in accordance with at least one embodiment described herein.

### DESCRIPTION OF EMBODIMENTS

Some embodiments discussed herein are generally related to advertisement and actual benefit distribution in a geocaching/treasure hunting environment. The geocaching/treasure hunting environment allows advertisers to sponsor geoseeds and/or areas surrounded by a digital fence and to provide an actual benefit such as a gift card for locating the sponsored geoseed or sponsored area. Seekers may interface with a geocache/treasure hunting server that communicates coordinates of the geoseeds or the digital fence to the seekers. The geocache/treasure hunting server may also host an auction through which advertisers can bid on sponsorships of specific geoseeds. The geocache/treasure hunting server also hosts games in which multiple seekers compete. The games involve virtual game actions and actual game actions. The actual game actions include locating the geoseeds or physically entering the areas surrounded by the digital fences. Some additional embodiments are explained with reference to the accompanying drawings.

FIG. 1 illustrates a block diagram of an example geocaching/treasure hunting environment (geocaching environment) 100 in which some embodiments may be implemented. The geocaching environment 100 may be configured to support geocaching activities and/or global positioning system (GPS) searching activities (e.g., those involving digital fences). The geocaching environment 100 in some embodiments enables seekers 102A and 102B (generally, seeker 102 or seekers 102) to participate in a game hosted at least partially by a geocache/treasure hunting server (geocache server) 116. Additionally, the geocaching environment 100 may enable an advertiser 124 to distribute advertisements in geocaches and geoseeds hidden and found by the seekers 102 and/or in areas surrounded by digital fences. Furthermore, the geocaching environment 100 may enable the advertiser 124 to provide an actual benefit to the seekers 102 for locating the geocache, the geoseed, for physically entering an area surrounded by a digital fence, or any combination thereof.

For example, the advertiser 124 may sponsor a geoseed, which may be hidden in a particular geocache. The advertiser 124 may place an advertisement and/or an actual benefit in the geocache in which the sponsored geoseed is placed. The seeker 102 may then interface with the geocache server 116 to receive coordinates of the particular geocache. When the seeker 102 locates the sponsored geoseed, the seeker 102 may communicate verification information to the geocache server 116 evidencing the location of the geoseed. In response, the seeker 102 may be awarded the actual benefit. As another example, the advertiser 124 may sponsor an area surrounded by a digital fence. The advertiser 124 may place an advertisement and/or an actual benefit in the area. The seeker 102 may then interface with the geocache server 116 to receive coordinates of the digital fence. When the seeker 102 physically enters the area, the seeker 102 may communicate verification information and/or positional data to the geocache server 116 evidencing that the seeker 102 has physically entered the area. In response, the seeker 102 may be awarded the actual benefit.

Additionally, the geocache server 116 may host a game in which the seekers 102 may participate. The game may involve locating geocaches and/or physically entering into an area surrounded by digital fences. For example, the sponsored geoseed, another geoseed, or an area surrounded by a digital fence may also have a virtual benefit associated with it. The virtual benefit may be used as points in the game, for instance. Play of the game by the seekers 102 may include locating multiple geocaches to recover the virtual benefits, physically entering multiple areas surrounded by digital fences, along with other sub-games which may have associated therewith additional virtual benefits in a competitive setting.

The geocaching environment 100 depicted in FIG. 1 includes devices 104A and 104B (generally, device 104 or devices 104) associated with the seekers 102. The geocaching environment 100 also includes a third party server 112, a social media server 114, and the geocache server 116. The devices 104, the third party server 112, the social media server 114, and the geocache server 116 are communicatively coupled via a network 140. In the geocaching environment 100, the geocache server 116 includes a geocache/treasure hunting module (geocache module) 130, a game module 134, and an ad module 132. Additionally, the devices 104 include client modules 120A and 120B (generally, client module 120 or client modules 120). The client modules 120, the geocache module 130, the game module 134, and the ad module 132 are configured to communicate information and data via the network 140 that may be used in geocaching by the seekers 102, locating digital fences by the seekers 102, playing the game, sponsoring geoseeds, awarding actual benefits, as well as one or more other operations as described herein.

The network 140 may be wired or wireless, and may have numerous different configurations including a star configuration, token ring configuration, or other configurations. Furthermore, the network 140 may include a local area network (LAN), a wide area network (WAN) (e.g., the Internet), a metropolitan area network (MAN), a portion of the Internet, a portion of the Public Switched Telephone Network (PSTN), and/or other interconnected data paths across which multiple devices may communicate. In some implementations, the network 140 may be a peer-to-peer network. The network 140 may also be coupled to or include portions of a telecommunications network for sending data in a variety of different communication protocols. In some implementations, the network 140 includes BLUETOOTH® communication networks or a cellular communications network for sending and receiving data including via short messaging service (SMS), multimedia messaging service (MMS), hypertext transfer protocol (HTTP), direct data connection, wireless application protocol (WAP), email, etc.

The third party server 112 may include a hardware server that includes a processor, memory, and network communication capabilities. In the illustrated implementation, the third party server 112 is coupled to the network 140. The third party server 112 may send and receive data to and from one or more of the devices 104, the geocache server 116, and the social media server 114 via the network 140. The third party server 112 may be associated with the advertiser 124. For example, the advertiser 124 may own, operate, or regularly access the geocaching environment 100 via the third party server 112. The advertiser 124 may include any entity including an individual, a corporate entity, or government entity.

The advertiser 124 may communicate with the ad module 132 of the geocache server 116 via the network 140 and the third party server 112. For example, the ad module 132 may host or facilitate an automated or semi-automated auction for advertising opportunities. The advertising opportunities may include, but are not limited to, incorporating an advertisement in a geoseed or an area surrounded by a specific digital fence, assigning a digital fence within a proximity of an establishment of the advertiser 124, and sponsoring a specific seeker 102. The advertiser 124 may communicate a bid offered for the advertising opportunities to the geocache server 116. For instance, the advertiser 124 may communicate a bid for sponsorship of a geoseed or area surrounded by a specific digital fence used in a specific game. An acceptance or a rejection of the bid may be communicated from the geocache server 116 to the third party server 112 via the network 140. The advertiser 124 may receive the acceptance at the third party server 112. Additionally, the advertiser 124 may access information such as game information 142 and/or seeker information 128 stored on memory 122. The advertiser 124 may use the information as bases for the bids.

In some embodiments in which the advertiser 124 bids on an advertising opportunity, after a bid is accepted, the sponsorship of the advertiser 124 may be associated with a geoseed and/or a digital fence. The advertiser 124 may then communicate the actual benefit provided for locating the geoseed. Additionally, the geocache server 116 may communicate coordinates of the sponsored geoseed or the sponsored digital fence to the advertiser 124 via the third party server 112. The advertiser 124 may then physically place the actual benefit and/or a particular geoseed in a geocache containing the sponsored geoseed or in the sponsored digital fence.

The third party server 112 may also be used to communicate information and data related to the actual benefit. For example, the advertiser 124 may provide an actual benefit such as a coupon or a gift card to the geocache server 116 via the network 140. Additionally, the third party server 112 may be used to communicate advertisements to be used in sponsored geoseeds or sponsored digital fences, instructions for redemption of the actual benefits, and details of digital fences to the geocache server 116 via the network 140.

In some embodiments, the seekers 102 may access or view information communicated between the third party server 112 and the geocache server 116. Specifically, the seekers 102 may use the devices 104 to view the information. For example, the seekers 102 may view the information related to the actual benefits via the network 140.

The seeker 102 may be allowed to select the advertiser 124 as a sponsor from a set of advertisers. The seeker 102 may then be associated with the advertiser 124 to cooperatively promote products or services of the advertiser 124.

The social media server 114 may include a hardware server that includes a processor, memory, and network communication capabilities. In the illustrated implementation, the social media server 114 is coupled to the network 140. The social media server 114 may send and receive data to and from one or more of the devices 104, the geocache server 116, and the third party server 112 via the network 140. The social media server 114 includes a social media application 138 that supports a social network. The social network includes a social structure in which the seekers 102 and/or multiple other users may be connected by a common feature. The common feature includes relationships or connections such as friendship, family, work, an interest (e.g., geocaching), and the like. The common features may be provided by the social media application 138. For example, the social media application may provide explicitly defined relationships and relationships implied by social connections between online users. The relationships and/or the common features may form a social graph in the social network.

In some examples, the social graph can reflect a mapping of the seekers 102 and the other users and how they can be related. Furthermore, the social media server 114 and the social media application 138 may be representative of one social network and that there may be multiple social networks coupled to the network 140, each having its own server, application, and social graph. For example, a first social network may be more directed to business networking, a second may be more directed to or centered on academics, a third may be more directed to local business, a fourth may be directed to dating and others may be of general interest or a specific focus. In some embodiments, the social media application 138 may be configured to provide a user interface to one or more of the seekers 102 operating one of the devices 104. The user interface provides to the seekers 102 an interface through which the seekers 102 may interact with the geocache server 116, a module (e.g., 130, 132, and 134) included therein, the devices 104 of other seekers 102 and/or the third party server 112.

The social network includes a service that provides a feed describing one or more social activities specific to one of the seekers 102 or to another entity. For example, the feed provided by the social network may allow the seekers 102 or another entity to describe actions that may be relevant to a game, events involving the seekers 102, expressed thoughts or opinions, and the like.

In some embodiments, the game module 134 may combine with the social media application 138 to provide a game interface to the seekers 102. For example, the social media application 138 may be configured to host at least some portion of a game cooperatively with the game module 134. Game actions in the game may be taken through interaction via the social media application 138 and/or the game module 134. Additionally, results of the game actions and seeker information 128 accessible via the game module 134 may be reflected in the social network (e.g., in the feed). For example, the seeker 102 can locate a geoseed or physically enter an area surrounded by a digital fence. For locating the geoseed or entering the area, the seeker 102 can be awarded an actual benefit and a virtual benefit associated with the geoseed or the area. When location of the geoseed or entry into an area surrounded by a specific digital fence is authenticated, the addition of the virtual benefit may be reflected in the social network and in the game module 134. If the addition of the virtual benefit unlocks or increases status in the game, then the seeker 102 can take a subsequent game action using the game module 134 and/or the social media application 138.

Additionally or alternatively, the geocache module 130 and/or the ad module 132 may interface with the social media application 138 to provide one or more operations attributed to the geocache module 130 or the ad module 132 via the social network. Moreover, the social media application 138 may be configured in some embodiments to perform one or more of the operations attributed to the geocache module 130 and/or the ad module 132. For example, the seekers 102 may access maps or seeker feedback via the social network. Additionally, the seekers 102 may view actual benefits or interface with the advertiser 124 via the social network.

The devices 104 may include a computing device that includes a processor, memory, and network communication capabilities. Generally, the devices 104 enable interaction between the seekers 102 and the other components of the geocaching environment 100. The seekers 102 may include individuals or one or more groups of individuals who may search for geoseeds, digital fences, and/or actual benefits associated therewith. The seekers 102 may determine locations of geocaches and/or digital fences by accessing the network 106 through the device 104. The seekers 102 may then locate the geocache or physically enter the area surrounded by the digital fences. When the seekers 102 locate the geocache, the seeker 102 may log the find within the geocache and/or in a website 126 utilizing the device 104. Additionally, the seekers 102 may place the geoseed into a second geocache or another type of hidden container. The seekers 102 may then hide the second geocache. The seekers 102 may log the new location of the second geocache with the geocache server 116. The seeker 102 may also log their finds, experiences, photos, and obtain new geocache and/or geoseed coordinates through interfacing with the geocache server 116 or in the social network.

One or both of the devices 104 may include a laptop computer, a desktop computer, a tablet computer, a mobile telephone, a smart phone, a personal digital assistant (PDA), a mobile email device, a portable game player, a portable music player, a television with one or more processors embedded therein or coupled thereto, or other electronic device capable of accessing the network 140. The device 104 may access the social media server 114, the geocache server 116, the third party server 112, or any combination thereof via the network 140.

The devices 104 may include the client modules 120. The client modules 120 may be configured to enable interaction between the seekers 102 (e.g., between a first seeker 102A and a second seeker 102B), between the seekers 102 and the geocache server 116, between the seekers 102 and the social media server 114, or any combination thereof. The client modules 120 may be configured to provide a user interface to the seeker 102 that may allow the seeker 102 to interact with one or more of the geocache module 130, the ad module 132, the game module 134, and the social media application 138.

For example, the client modules 120 may provide access to maps of geocaches and/or digital fences, lists of geocaches and/or digital fences, seeker feedback, and other geocache-related information that may be stored and/or controlled by the geocache module 130. Additionally, the client module 120 may enable the seeker 102 to communicate a seeker inquiry to the geocache module 130. In response to the seeker inquiry, the geocache module 130 may provide coordinates of a geocache or a digital fence to the client module 120. The coordinates may be provided to the device 104 as digital data, which may be loaded automatically or semi-automatically to the client module 120. As the seeker 102 attempts to locate the geocache or the digital fence, the client module 120 may track a current location with reference to the coordinates communicated to the device 104 by the geocache module 130. In some embodiments, the current location may be determined from global positioning system (GPS) signals, for instance. In some embodiments, after the seeker 102 locates the geocache and/or physically enters an area surrounded by the digital fence, the client module 120 may communicate verification information to the geocache server 116 via the network 140.

The client modules 120 may also enable observation of activities between the seekers 102. For example, the first seeker 102A may be able to observe progress the second seeker 102B is making towards locating a geocache. In this example, the first seeker 102A may receive updates on a first device 104A in the form of text messages, email messages, pushed digital messages, links to a feed in the social network, or any other suitable digital messaging.

Additionally, the client module 120 may allow the seeker 102 to interact with the ad module 132. For example, the seeker 102 may view sponsored geocaches, view actual benefits associated with geoseeds or digital fences, redeem an actual benefit, gain access to the actual benefit, and access descriptions of the actual benefits. In some embodiments, the seekers 102 may interact with the ad module 132 to select an advertiser (e.g., 124) as a sponsor.

Additionally, the client module 120 may allow the seeker 102 to interact with the game module 134. For example, the seeker 102 may enter into a game (e.g., choose to participate in the game), select a particular style of game, and take a game action in an ongoing game using the client module 120. For example, a user interface provided by the client module 120 may include a game user interface that displays a list of games the seeker 102 may join, current or past standings of the seekers 102 participating in a game, and the like.

Additionally, the client module 120 may allow or provide personalized access to the geocache server 116. In some embodiments, one or more of the geocache module 130, the ad module 132, and the game module 134 may be accessed using a seeker login. The seeker login may link the seeker 102 to a personalized account. For example, the seeker 102 may provide seeker information 128 including, but not limited to, age, gender, geo cache experience, associate seekers, and the like. Additionally, through participation in games and/or locating geo caches or digital fences, the seeker information 128 and/or the game information 142 may be updated. For instance, when the seeker 102 locates a particular geocache, the seeker information 128 and/or the game information may include an indication reflecting the located geocache, a virtual benefit received, an actual benefit received, an updated standing in a game, and the like. The seeker information 128 may be stored in the memory 122.

Additionally, the client module 120 may at least partially enable the seeker 102 to interface with the social media application 138. In some embodiments, the client module 120 may interface with the game module 134 indirectly through the social media application 138. Additionally or alternatively, the game module 134 may communicate information to the seeker 102 by posting the information in the feed supported in the social media application 138.

One or more of the functions described herein that are attributed to the client module 120 may be performed by a mobile application or a thin-client application. Additionally, in some embodiments, one or more of the devices 104 may perform one or more of the operations described herein by interfacing with a browser. In these and other embodiments, the geocache module 130, the game module 134, the ad module 132, the social media application 138, the geocache server 116, or some combination thereof may provide and support a user interface to the seekers 102 on the devices 104 via the browser.

The geocache server 116 may include a hardware server that includes a processor, memory, and network communication capabilities. In the illustrated implementation, the geocache server 116 is coupled to the network 140. The geocache server 116 may send and receive data to and from one or more of the devices 104, the social media server 114, and the third party server 112 via the network 140. The geocache server 116 may include the geocache module 130, the game module 134, and the ad module 132.

The geocache module 130, the game module 134, and the ad module 132 may be configured to provide the seekers 102 with actual benefits for locating geo caches and/or physically entering digital fences. Additionally, the geocache module 130, the game module 134, and the ad module 132 may be configured to enable sponsorship by the advertiser 124 of geoseeds found in geocaches and/or digital fences.

In some embodiments the geocache module 130 may be configured to receive a seeker inquiry. The seeker inquiry may be communicated from one of the devices 104 via the network 140. The seeker inquiry may identify a specific geocache or geoseed that the seeker 102 wants to locate. Additionally or alternatively, the seeker inquiry may identify a specific digital fence the seeker 102 wants to enter and/or the seeker inquiry may identify a specific actual benefit or a specific virtual benefit the seeker 102 wants to be awarded. In response to the seeker inquiry, the geocache module 130 may provide coordinates of one or more corresponding geocaches and/or digital fences. For example, if a seeker inquiry identifies a specific actual benefit, the geocache module 130 may communicate the coordinates of one or more geocaches that have associated therewith the specific actual benefit. The one or more geocaches may include geocaches in which a geoseed sponsored by the advertiser 124 is placed.

The coordinates may be communicated to the device 104 via the network 140 and/or posted to the social network. The coordinates may be loaded to the device 104 and/or to the client module 120. In circumstances in which coordinates of multiple geocaches are communicated, the seeker 102 may select one of the coordinates. The coordinates may then be loaded to the client module 120.

The geocache module 130 may identify an actual benefit provided for locating the geoseed and or entering an area surrounded by the digital fence. The actual benefit may be associated with the advertiser 124. The actual benefit may include any good or service. For example, the advertiser 124 may include a hiking boot company and the actual benefit may include a certificate for a pair of boots.

In some embodiments the geocache module 130 may identify the actual benefit before the seeker 102 locates the geocache or enters the area surrounded by the digital fence. For example, when the geocache module 130 communicates the coordinates, the geocache module 130 may also identify the actual benefit. Additionally or alternatively, the geocache module 130 may identify the actual benefit in a communication after the communication of the coordinates, the geocache module 130 may identify the actual benefit prior to receiving the seeker inquiry, and the geocache module 130 may identify the actual benefit after the seeker 102 locates the geocache or the digital fence. For example, the seeker 102 may locate the geocache using the coordinates loaded onto the device 104. The geocache module 130 may identify the actual benefit to the seeker 102 when the seeker 102 logs the location of the geocache.

The geocache module 130 may also be configured to receive the confirmation signal. The confirmation signal may indicate that the seeker 102 has located a geocache or has entered an area surrounded by the digital fence. The confirmation signal may verify that the seeker 102 has actually located the geoseed or actually entered the area surrounded by a digital fence. The confirmation signal may include verification information that may be specific to a geoseed or may include a signal indicating a current location of the seeker 102 from which the geocache server 116 may determine whether the seeker has physically entered the area surrounded by the digital fence.

The verification information may include, but is not limited to, geoseed identifying information, a digital code, a picture of the geoseed, and redemption of the actual benefit. The geoseed identifying information may include a specific word, a specific phrase, serial number, a name, and the like. The digital code may include an alpha-numeric code, a numeric code, a binary code, a quick response (QR) code, a bar code, and the like. The geoseed identifying information and/or the digital code may be communicated to the geocache server 116 using the device 104. For instance, the seeker 102 may type the geoseed identifying information and/or the digital code into a user interface provided via the client module 120 or the website 126. The digital code may also be scanned or photographed. The scanned or photographed digital code may then be communicated to the geocache server 116. In some instances, the geoseed may include a coin, for instance, that does not include a digital code or the geoseed identifying information. In these instances, the seeker 102 may take a picture of the geoseed. The picture may be communicated to the geocache server 116 in a confirmation signal.

In some embodiments, the confirmation signal may be communicated when the seeker redeems the actual benefit. For example, the actual benefit may be placed inside the geocache. When the seeker 102 locates the geocache, the seeker 102 may take the actual benefit. The seeker 102 may then redeem the actual benefit, which may indicate to the geocache server 116 that the seeker 102 located the geocache.

In circumstances in which the seeker 102 is locating a digital fence, the device 104 may include a system that determines the physical location of the device 104. For example, the device 104 may include a GPS receiver. In response to the device 104 (and thus the seeker 102) entering the area surrounded by the digital fence, the device 104 may communicate a confirmation signal including locational data of the device 104. In some embodiments, the locational data and/or the confirmation signal may be at least partially generated and/or communicated by the client module 102 via the network 140.

The geocache module 130 may be configured to authenticate the verification information. For example, the geocache module 130 may store a verification information record that identifies verification information of one or more of the geoseed. The geocache module 130 cross-checks the received verification information with that in the verification information record.

In some embodiments, the geocache module 130 may also communicate to the device 104 of the seeker 102 a message indicating that the seeker 102 is entitled to the actual benefit. For example, in response to a determination that the seeker 102 has physically entered the area surrounded by the digital fence, the geocache module 130 may communicate a message to the seeker indicating that the seeker is entitled to the actual benefit.

The geocache module 130 may be configured to award to the seeker 102 the identified actual benefit. For example, the geocache module 130 may apply a financial credit to a personalized account of the seeker 102 or mail the actual benefit to the seeker 102. Additionally or alternatively, the geocache module 130 may enable access to the actual benefit. For example, the geocache module 130 may send a digital representation of the actual benefit to the device 104 of the seeker 102 or send a message to the advertiser 124 via the network 140 authorizing access to the actual benefit.

The ad module 132 may be configured to communicate or to otherwise provide access to a portion of the seeker information 128 and the game information 142 to the advertiser 124. For example, the advertiser 124 may want access to the seeker information 128 and/or the game information 142 to determine if and what amount to bid on a geoseed or digital fence. Additionally, the advertiser 124 may want access to the seeker information 128 and/or the game information 142 to determine a suitable actual benefit to provide in exchange for locating a geoseed or entering an area surrounded by a digital fence.

The ad module 132 may receive a bid from the advertiser 124 to sponsor the geoseed or an area surrounded by a particular digital fence. For example, the ad module 132 may host or facilitate an auction in which bids are submitted to sponsor geoseed and/or digital fences. The ad module 132 may accept the bid from the advertiser 124 may reject the bid from the advertiser 124. In response to accepting a bid of the advertiser 124, the ad module 132 may associate a sponsorship of the geoseed or the digital fence with the advertiser 124.

Additionally, in some embodiments, the ad module 132 may receive an indication of the actual benefit from the advertiser 124. The ad module 132 may then communicate the actual benefit to the geocache module 130. The actual benefit may include an object placed in a geocache. For example, the actual benefit may include a T-shirt having a logo of the advertiser 124 printed on it. Accordingly, the ad module 132 may provide coordinates of the geoseed, the geocache, or the digital fence to the advertiser to enable placement of the actual benefit in the geocache or the digital fence.

The game module 134 may be configured to host and support games in the geocaching environment 100. The game module 134 may be accessed by the other components of the geocaching environment 100 directly or via, the network 140. The seeker 102 may use the device 104 to access, send data to, and receive data from the website 126, the social media application 138, the game module 134, or any combination thereof to participate in the games. In some embodiments, the game module 134 may include an introduction mechanic that can introduce the seekers 102 to the games on the game module 134 and to other seekers 102 engaged with the game module 134, or provide help when encountering a common in-game obstacle.

The games hosted or supported by the game module 134 may include multiple game actions. The game actions include any step or play performed by the seekers 102 in furtherance of the game. The game may include one or more virtual game actions and one or more actual game actions. The virtual game actions may be performed through communication of digital data via the network 140. The actual actions may be performed in a real-world environment.

The games may be developed based upon a treasure hunting theme. The game may include multiple levels, hidden accesses, etc. To achieve the multiple levels and/or hidden access, codes may be employed that may require the seeker 102 to perform one or more game actions. The game actions may range from menial to complex.

A geocache may include an item such as a portion of the clues that may be used in the game. The game module 134 may prompt the seeker 102 for information included in the item. After the seeker 102 has entered the information, the game module 134 may enable the seeker to perform one of the one or more virtual potential game actions based on the information included in the item.

For example, with combined reference to FIGS. 1 and 3, game actions may include deciphering a set of clues 300 contained in multiple geoseeds. In this example, a group of geoseeds may each include one clue portion 302 of the set of clues 300. The clue portions 302 may be hidden on a card in some instances. When the seeker 102 locates the set of clues 300, a code may be deciphered. The code may be used in the game to receive points, to advance in the game, or take some game action.

For example in the set of clues 300 the code may include:

REALM.HTM

WHAT MONTH WERE YOU BORN?

SECOND LINE SEVENTH WORD FROM THE RIGHT

After the code is deciphered, the deciphered code may be used in the game as a question. The question may incorporate the seeker information 128, which may allow answers to be specific to the seeker 102. The game module 134 may match an answer input to the seeker information 128. For example, in response to the deciphered code above, the seeker 102 may enter the month of birth of the seeker 102. The answer to the deciphered code may be entered into the website 126, the game module 134, the social network, or any combination thereof. A correct answer may allow the seeker 102 to advance, gain points, or receive numerous other benefits in the game.

Additionally, the deciphered code may be used as a question relevant to the geoseed. For instance, the third sentence “SECOND LINE SEVENTH WORD FROM THE RIGHT” may refer to a disclaimer statement. The disclaimer statement may be printed on a back of a card on which one or more of the clue portions 302 are printed. In this case, the answer may be “card,” and the disclaimer statement may include:

Disclaimer Statement
Holder of this card is not required to purchase any business materials or services in order to use this card. CodeGeo does not warrant the function or use of this card.

As above, an answer to the deciphered code may be entered into the website 126, the game module 134, the social network, or any combination thereof. A correct answer may allow the seeker 102 to advance, gain points, or receive numerous other benefits in the game.

Additionally, the deciphered code may progress the seeker 102 through the game. For example, the above deciphered code “REALM.HTM” may be configured to open a new website page. When the seeker 102 discovers that “REALM.HTM” opens a new website page, the seeker 102 may open the website page. The website page may include fields including: a seeker name, a card serial number, and a card code. When the seeker 102 correctly enters the clues/questions into the fields, the new website can open another webpage that appears to be a blog between two users. The blog may appear to be a conversation discussing a treasure and an additional clue to a location of the treasure. The seeker 102 may proceed to find the treasure and advance in the game. Thus, the code decipher process may be one way in which a game administrator may create multiple levels of the game.

The clue portions 302 may be digitally generated by devices such as one time password (OTP) devices. Additionally, the clue portions 302 may be printed with thermo-graphic ink. Additional technologies and techniques can be employed inspiring the seeker 102 to continue her search, provide the sense of urgency, and extend the length of the game.

Referring back to FIG. 1, another game may include a contest that is played by integrating information from geoseeds, identification (ID) cards, multiple real-world sources, or some combination thereof with an online game. In the online game, the seekers 102 compete to earn points. The seekers 102 may be ranked based on a total number of points and/or a level of achievement the seeker 102 has obtained. In addition, the seekers 102 may be allowed to select a sponsor from a set of advertisers (e.g., the advertiser 124). The seekers 102 may earn points, which may contribute to totals for ranking. The sponsors may have flexibility regarding how to award the seekers 102 that have selected them.

The game may include an adventure in which a plurality of seekers accumulates virtual benefits and actual benefits through location of a plurality of geocaches and through participation in one or more virtual games. For example, the seeker 102 may also choose to participate in an adventure. The adventure may include, but is not limited to, solving numerous puzzles; participating in live interactive games; or answering timed questions. The seeker 102 may gain points for the games and/or puzzles as well as how many geoseeds the seeker 102 has found or planted and/or how far an individual geoseed has traveled. In some embodiments, the puzzles and codes that the seeker 102 uncovers may lead the seeker 102 to coordinates of other geocaches.

In these and other embodiments, the game module 134 may be further configured to identify a virtual benefit that is provided for locating the geoseed, for performing a game action, entering an area surrounded by a digital fence, or any combination thereof.

The game module 134 may also be configured to update the seeker information 128 of the seeker 102 to reflect the virtual benefits. Additionally or alternatively, the game module 134 may be configured to post some portion of the updated seeker information 128 to a social network.

In some implementations, the geocache server 116 may include the website 126 which may be configured specifically for geocaching, gaming, providing actual benefits to the seekers 102, and including advertising in the geocaches and/or digital fences. For example, the website 126 may include a user interface created for or otherwise supporting communication of information in the geocaching environment 100. The website 126 may be further configured to provide to the seeker 102 and/or the advertiser 124 an interface via a browser.

The website 126 may further provide the login page to the seekers 102. The website 126 may enable the seekers 102 to find and obtain benefits (actual or virtual) of the geoseed and/or communicate information to the geocache server 116 as described herein. The website 126 may require a periodic (e.g., weekly, annual, or monthly) membership. Additionally or alternatively, the website 126 may be accessible via an electronic activation key that may involve the seeker 102 solving and unlocking one or more games and/or puzzles, for instance.

In some embodiments, the seekers 102 and/or an advertiser 124 may be issued an ID card. The ID card may be used as a membership card for access to the website 126. The ID card may contain user information specific to the seeker 102 or the advertiser 124. The ID card may also provide an additional level of security required to access the website 126. Additionally, the ID card can be used to unlock and/or access certain geocaching game features or levels. Game-related characteristics may also be enhanced by leveraging the ID card in conjunction with information located on a geoseed, which may result in seeker-specific benefits. The ID cards may also be personalized to contain graphics provided by the seeker 102 and/or the advertiser 124.

Modifications, additions, or omissions may be made to the geocaching environment 100 without departing from the scope of the present disclosure. Specifically, embodiments depicted in FIG. 1 include one third party server 112, one social media server 114, one geocaching server 116, and two devices 104. However, the present disclosure applies to a geocaching environment 100 that may include multiple third party servers, multiple social media servers, multiple geocaching servers, two or more devices, or any combination thereof. Moreover, the separation of various components in the embodiments described herein is not meant to indicate that the separation occurs in all embodiments. Moreover, it may be understood with the benefit of this disclosure that the described components may be integrated together in a single component or separated into multiple components.

The client module 120, the social media application 138, the geocache module 130, the game module 134, and the ad module 132 may include code and routines for performing the operations discussed herein. In some embodiments, one or more of the client modules 120, the social media application 138, the geocache module 130, the game module 134, and the ad module 132 act in part as a thin-client application that may be stored on a computing device and in part as components that may be stored on one or more hardware servers, for instance. In some embodiments, the client module 120, the social media application 138, the geocache module 130, the game module 134, the ad module 132, or any combination thereof may be implemented using hardware including a field-programmable gate array (FPGA) or an application-specific integrated circuit (ASIC). In some other instances, the client module 120, the social media application 138, the geocache module 130, the game module 134, the ad module 132, or any combination thereof may be implemented using a combination of hardware and software.

In the geocaching environment 100 or any component (e.g., 104, 112, 114, 116) thereof, memory such as the memory 122, may include a non-transitory memory that stores data for providing the functionality described herein. The memory may be included in storage that may be a dynamic random access memory (DRAM) device, a static random access memory (SRAM) device, flash memory, or some other memory devices. In some embodiments, the storage also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

Referring now to FIG. 2, examples of the geocache module 130, the game module 134, and the ad module 132 are shown in more detail. FIG. 2 is a block diagram of a computing device 200 that includes the geocache module 130, the game module 134, and the ad module 132, a processor 224, a memory 222, and a communication unit 226. The components of the computing device 200 may be communicatively coupled by a bus 220. The computing device 200 may include the geocache server 116 of FIG. 1.

With combined reference to FIGS. 1 and 2, the processor 224 may include an arithmetic logic unit (ALU), a microprocessor, a general-purpose controller, or some other processor array to perform one or more operations described herein. The processor 224 may be coupled to the bus 220 for communication with the other components (e.g., 130, 132, 134, 222, 224, and 226). The processor 224 generally processes data signals and may include various computing architectures including a complex instruction set computer (CISC) architecture, a reduced instruction set computer (RISC) architecture, or an architecture implementing a combination of instruction sets. Although FIG. 2 includes a single processor 224, multiple processors may be included in the computing device 200. Other processors, operating systems, and physical configurations may be possible.

The memory 222 may be configured to store instructions and/or data that may be executed by the processor 224. The memory 222 may be coupled to the bus 220 for communication with the other components. The instructions and/or data may include code for performing the techniques or methods described herein. The memory 222 may be a DRAM device, an SRAM device, flash memory, or some other memory device. In some embodiments, the memory 222 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. In the depicted embodiment, the memory 222 includes the memory 122. The memory 122 may be configured to store and/or enable access to the game information 142 and/or the seeker information. In some embodiments, the memory 122 or some portion thereof may be located remotely and accessed via the network 140.

The communication unit 226 may be configured to transmit and receive data to and from other systems. For example, the communication unit 226 may enable communication via the network 140 with the devices 104, the third party server 112, the social media server 114, and the geocache server 116, depending on implementation of the computing device 200. The communication unit 226 may be coupled to the bus 220. In some embodiments, the communication unit 226 includes a port for direct physical connection to the network 140 or to another communication channel. For example, the communication unit 226 may include a USB, SD, CAT-5, or similar port for wired communication. In some embodiments, the communication unit 226 includes a wireless transceiver for exchanging data via communication channels using one or more wireless communication methods, including IEEE 802.11, IEEE 802.16, BLUETOOTH®, or another suitable wireless communication method.

In some embodiments, the communication unit 226 includes a cellular communications transceiver for sending and receiving data over a cellular communications network including via SMS, MMS, hypertext transfer protocol (HTTP), direct data connection, WAP, email, or another suitable type of electronic communication. In some embodiments, the communication unit 226 includes a wired port and a wireless transceiver. The communication unit 226 may also provide other conventional connections for distribution of files and/or media objects using standard network protocols including transmission control protocol/internet protocol (TCP/IP), HTTP, HTTP secure (HTTPS), and simple mail transfer protocol (SMTP), etc.

In the embodiment of FIG. 2, the geocache module 130 includes an identification module 204, a communication module 202, a determination module 206, an authentication module 208, and an award module 210, an update module 232, and a social media module 218. The ad module 132 may include an ad communication module 212, an association module 214, and an acceptance module 216. The game module 134 may include a prompt module 228 and an action module 230. The modules (e.g., 130, 132, 134, 202, 204, 206, 208, 210, 212, 214, 216, 218, 228, 230, and 232) are collectively, referred to as the modules 240.

Each of the modules 240 may be implemented as software including one or more routines configured to perform one or more operations. The modules 240 may include a set of instructions executable by the processor 224 to provide the functionality described herein. In some instances, the modules 240 may be stored in or at least temporarily loaded into the memory 222 of the computing device 200 and may be accessible and executable by the processor 224. One or more of the modules 240 may be adapted for cooperation and communication with the processor 224 and components of the computing device 200 via the bus 220.

The ad communication module 212 may be configured to handle communications between the ad module 132 and other components of the computing device 200 (e.g., 130, 134, 222, 224, and 226). The ad communication module 212 may be configured to send and receive data via the communication unit 226 to outside systems (e.g., via the network 140). In some instances, the ad communication module 212 may cooperate with the other modules 240 to receive and/or forward, via the communication unit 226, data from the components. For example, the ad communication module 212 to communicate a portion of the seeker information 128 and the game information 142 to the advertiser 124. The advertiser 124 may use the seeker information 128 and the game information 142 as bases for bids.

The ad communication module 212 may receive a bid from the advertiser 124. The bid may include a bid to sponsor a geoseed, a set of geoseeds, an area surrounded by the digital fence, one or more of the seekers 102, and the like. The ad communication module 212 may communicate the bid to the acceptance module 216.

The acceptance module 216 may be configured to receive bids and determine whether to accept a bid. In some embodiments, the acceptance module 216 may accept the bid from the advertiser 124 to sponsor the geoseed, the set of geoseeds, the area surrounded by the digital fence, one or more of the seekers 102, and the like. The acceptance module 216 may communicate a signal indicating acceptance of the bid to the association module 214.

The association module 214 may be configured to receive the signal indicating acceptance of the bid and associate the sponsorship of the advertiser 124 and the geoseed, the set of geoseeds, the area surrounded by the digital fence, one or more of the seekers 102, and the like. The ad communication module 212 may then receive an indication of the actual benefit provided by the advertiser 124 for locating of the geoseed, the set of geoseeds, the area surrounded by the digital fence, and the like. The ad communication module 212 may communicate coordinates to the advertiser 124. The advertiser 124 may then place the actual benefits in the geocache(s) and/or within the digital fence(s).

The communication module 202 may be configured to handle communications between the geocache module 130 and other components of the computing device 200 (e.g., 132, 134, 222, 224, and 226). The communication module 202 may be configured to send and receive data via the communication unit 226 to outside systems (e.g., via the network 140). In some instances, the communication module 202 may cooperate with the other modules 240 to receive and/or forward, via the communication unit 226, data from the components. For example, the communication module 202 to receive a seeker inquiry. The seeker inquiry may be communicated via the network 140 to the communication unit 226. The seeker inquiry may then be communicated to the communication module 202 via the bus 220. In response to the seeker inquiry, the communication module 202 may communicate coordinates of a geocache and/or a digital fence. The coordinates of the geocache and/or the digital fence may be stored in the memory 222, for instance. The coordinates of the geocache and/or the digital fence may be communicated to the device 104 of the seeker 102 via the bus 220, the communication unit 226, and the network 140. The geocache may include a geoseed that is sponsored by the advertiser 124. The communication module 202 may communicate a signal indicating that the coordinates have been communicated to the identification module 204.

The identification module 204 may be configured to identify an actual benefit provided for locating the geoseed or entry into an area surrounded by the digital fence. The identification of the actual benefit may include communicating a message to the seeker 102 at the time of the seeker inquiry and/or communicating a message to the seeker 102 after the seeker 102 has located the geocache or entered the area surrounded by the digital fence. The communication module 202 may communicate the message to the seeker 102. The actual benefit may be associated with the advertiser 124 that sponsors the geoseed in the geocache or the area surrounded by the digital fence.

The communication module 202 may then receive a confirmation signal indicating the seeker 102 has located the geocache or entered the area. The confirmation signal may include verification information specific to the geoseed, for example. The communication module 202 may communicate the confirmation signal to the authentication module 208 and the update module 232.

The authentication module 208 may be configured to receive the confirmation signal from the communication module 202 and authenticate the verification information. The verification information may include, but is not limited to, geoseed identifying information, a digital code, a picture of the geoseed, and redemption of the actual benefit. Accordingly, the authentication module 208 may be configured with one or more subroutines that authenticate the verification information such as image analysis techniques, comparison tools, and the like. Moreover, the authentication module 208 may be communicatively coupled with a system that may identify redemption of the actual benefit. The authentication module 208 may then communicate a signal indication authenticity of the confirmation signal to the award module 210.

The update module 232 may be configured to receive the confirmation signal and update seeking information. In some embodiments, the update module 232 may update the seeker information 128 of the seeker 102 to reflect an actual benefit and/or a virtual benefit. The update module may communicate the updated seeker information 128 to the social media module 218. The social media module 218 may be configured to receive the updated seeker information and post some portion of the updated seeker information to the social network.

The award module 210 may be configured to receive signals indicating authenticity of confirmation signals and to award to the seeker 102 the identified actual benefit. In some embodiments, the award module 210 may communicate the actual benefit to the seeker 102 via the communication module 202. Additionally or alternatively, the award module 210 may communicate a message to the third party server 112, the device 104, or another outside system that enables the seeker 102 access to the actual benefit. For example, the actual benefit may include a gift card or a store credit. Use of the gift card or the store credit may involve activation. The award module 210 may communicate a message that activates the gift card or the store credit.

Additionally or alternatively, the communication module 202 may be configured to receive a seeker inquiry for an area surrounded by a digital fence. In response to the seeker inquiry, the communication module 202 may communicate coordinates of the digital fence. The area surrounded by the digital fence may be sponsored by the advertiser 124. The coordinates may be communicated via the bus 220, the communication unit 226, and the network 140. The communication module 202 may also communicate a signal to the identification module 204 indicating the coordinates of the digital fence have been communicated.

The identification module 204 may be configured to identify a second actual benefit that is provided for physically entering the area surrounded by the digital fence. The digital fence may be configured by a host or the advertiser 124. The identification of the actual benefit may include communicating a message to the seeker 102 at the time of the seeker inquiry and/or communicating a message to the seeker 102 after the seeker 102 has entered the area surrounded by the digital fence.

The determination module 206 may be configured to determine whether the seeker 102 has physically entered the area. In some embodiments, the determination module may determine whether the seeker 102 has physically entered the area based on locational data received from a mobile device such as the device 104 associated with the seeker 102. In response to a determination that the seeker 102 has physically entered the area, the determination module 206 may communicate a signal to the communication module 202 and the award module 210 indicating the seeker 102 has physically entered the area surrounded by the digital fence. The communication module 202 may communicate a message to the seeker 102 indicating that the seeker 102 is entitled to the second actual benefit. The award module 210 may then award to the seeker 102 the second actual benefit or enable access to the second actual benefit.

In some embodiments, the identification module 204 may be configured to identify a virtual benefit. The identification of the virtual benefit may include communicating a message to the seeker 102 at the time of the seeker inquiry and/or communicating a message to the seeker 102 after the seeker 102 has located the geocache. The communication module 202 may communicate the message to the seeker 102. The virtual benefit may be configured for use in a game involving geocaching. The game may include one or more virtual game actions performed through communication of digital data via the network 140 and one or more actual game actions performed in a real-world environment.

The geocache may have placed therein an item used in the game. In these and other embodiments, the prompt module 228 may be configured to prompt the seeker 102 for information included in the item. The prompt module 228 may communicate the information from the item to the action module 230.

The action module 230 may be configured to receive the information from the item and enable the seekers 102 to perform one or more game actions in the game. For example, the action module 230 may enable the seeker 102 to perform virtual game actions based on the information included in the item.

FIG. 4 illustrates an example map 400 that may be provided in the geocaching environment 100 of FIG. 1. With combined reference to FIGS. 1 and 4, the map 400 may be provided to the seeker 102 at the client module 120 and/or via the website 126. The map 400 may include locations of geocaches 402A-402D (generally, geocache 402 or geocaches 402) and a location of a digital fence 404. The geocaches 402 may include containers such as a letterbox, a treasure box, ammunition boxes, etc. The geocaches 402 may be distributed throughout a geographical area depicted in the map 400. The seeker 102 or an administrator may hide the geocaches 402 at specific coordinates. The coordinates may then be communicated to the geocache server 116 and indicated on the map 400. Additionally, the seeker 102 may re-hide one of the geocaches 402 after the seeker 102 locates the geocache 402. A new location may be communicated to the geocache server 116 and indicated on the map 400.

The digital fence 404 may be assigned by an administrator and/or the advertiser 124. The digital fence 404 may surround a general physical area of interest, a geocache (e.g., 402C in FIG. 4), a location relevant to the advertiser 124 (e.g., a store or location of an event), or some combination thereof. The digital fence 404 may be identified by a GPS location with or without a perimeter. The geometry of the digital fence 404 can be of any geometric shape such as a circle, a square, or any multi-sided configuration. The geometry may be based upon a time-related activity. For instance, the geometry may be based upon a time to travel within the digital fence 404, a time to travel across the area surrounded by the digital fence 404, a time to a center of the area surrounded by the digital fence 404, or a time to travel around the area surrounded by the digital fence 404. When the device 104 comes within the digital fence 404, the seeker 102 may be notified by and interact with the website 126, the geocache server 116, or another component of the geocaching environment 100.

FIG. 5 illustrates an example of the geocache 402 that may be implemented in the geocaching environment 100 of FIG. 1. The geocache 402 may include one or more geoseeds 502A-502C (generally, geoseed 502 or geoseeds 502) that integrate advertising and gaming. The geoseeds 502 may include an electronic device geoseed 502A, a card geoseed 502B, and a coin geoseed 502C. The electronic device geoseed 502A and the card geoseed 502B may include card numbers 504A and/or 504B, which may be used as verification information. The card geoseed 502B may also include a digital code 512 incorporated in a QR code. In some embodiments, the card geoseed 502B may be an actual benefit in that it may be the card geoseed 502B that can be used in a transaction.

The coin geoseed 502C may not contain a card number. To use the coin geoseed 502C, a seeker can take a picture of the coin geoseed 502C and communicate the picture to a geocaching server such as the geocaching server 116. Image analysis may be performed on the picture of the coin geoseed 502C to determine that the seeker is in possession of the coin geoseed 502C. One or more of the geoseeds 502 may include information used in a game.

The geocache 402 may also have placed therein a logbook 506 and one or more trinkets 508. The trinkets 508 may include key chains or small toys. The seeker may sign and date the logbook 506 to record her visit. The seeker may then take the trinket 508 and leave another trinket in the geocache 402. Some other examples of the trinket 508 can include toys, key chains, coins, tokens, and the like.

FIGS. 6A-6D are a flow diagram of an example method 600 of awarding an actual benefit in a geocaching environment, arranged in accordance with at least one embodiment described herein. The method 600 may be programmably performed in some embodiments by the computing device 200 described with reference to FIG. 2. Additionally or alternatively, the method 600 may be programmably performed by the geocache server 116 of FIG. 1. The geocache server 116 and/or the computing device 200 may include or may be communicatively coupled to a non-transitory computer-readable medium (e.g., the memory 222 of FIG. 2) having stored thereon or encoded therein programming code or instructions that are executable by a processor to perform or cause performance of the method 600. The geocache server 116 and/or the computing device 200 may include a processor (e.g., the processor 224 of FIG. 2) that is configured to execute computer instructions to cause or control performance of the method 600. Although illustrated as discrete blocks, various blocks may be divided into additional blocks, combined into fewer blocks, or eliminated, depending on the desired implementation.

Referring to FIG. 6A, the method 600 may begin at block 602. At block 602, a portion of seeker information and game information may be communicated to the advertiser. For example, with reference to FIG. 1, the seeker information 128 and the game information 142 may be communicated to the advertiser 124 via the network 140.

At block 604, a bid may be received from the advertiser to sponsor the geoseed. For example, with reference to FIG. 1, the geocache server 116 may receive a bid from the advertiser 124 communicated from the third party server 112 to the geocache server 116 via the network 140. Additionally or alternatively, a bid may be received from the advertiser to sponsor a digital fence.

At block 606, the bid may be accepted from the advertiser to sponsor the geoseed. For example, with reference to FIGS. 1 and 5, the ad module 132 may accept the bid from the advertiser 124 to sponsor the card geoseed 502B. Additionally or alternatively, the bid may be accepted from the advertiser to sponsor a digital fence (e.g., the digital fence 404).

At block 608, a sponsorship of the geoseed may be associated with the advertiser. For example, with reference to FIGS. 1 and 5, a sponsorship of the card geoseed 502B may be associated with the advertiser 124. Additionally or alternatively, a sponsorship of the digital fence may be associated with the advertiser.

At block 610, an indication may be received of the actual benefit provided for locating the geoseed from the advertiser. For example, with reference to FIGS. 1 and 5, an indication may be received at the ad module 132 of the actual benefit provided for locating the card geoseed 502B from the advertiser 124.

Referring to FIG. 6B, at block 612, a seeker inquiry 612 may be received. For example, with reference to FIG. 1, the geocache module 130 may receive a seeker inquiry. At block 614, coordinates of a geocache may be communicated. In some embodiments, the coordinates of the geocache may be communicated in response to the seeker inquiry. For example, with reference to FIGS. 1 and 5, the geocache module 130 may communicate coordinates of the geocache 402.

At block 616, the actual benefit provided for locating the geoseed may be identified. The actual benefit may be associated with the advertiser. In some embodiments, the actual benefit may be identified concurrently with the communication of the coordinates. For example, with reference to FIGS. 1 and 5, the geocache module 130 may identify to the seeker 102 the actual benefit for locating the card geoseed 502B. The actual benefit may be associated with the advertiser 124.

At block 618, a confirmation signal may be received. The confirmation signal may indicate that a seeker has located the geocache. The confirmation signal may include verification information specific to the geoseed. For example, with reference to FIGS. 1 and 5; the geocache module 130 may receive a confirmation signal from the seeker 102 after the seeker 102 has located the card geoseed 502B. The confirmation signal may include the card number 504B. At block 620, the verification information may be authenticated. For example, with reference to FIGS. 1 and 5, the geocache module 130 may authenticate the card number 504B. At block 622, the seeker may be awarded the actual benefit.

With reference to FIG. 6C, at block 624, a second actual benefit may be identified. The second actual benefit may be provided for physically entering an area surrounded by a particular digital fence. The digital fence may be configured by an administrator and/or an advertiser. For example, with reference to FIGS. 1 and 4, the geocache module 130 may identify the second actual benefit for entering the area surrounded by the digital fence 404.

At block 626, coordinates of the particular digital fence may be communicated. In some embodiments, the coordinates may be communicated to the device associated with the seeker. For example, with reference to FIGS. 1 and 4, the geocache module 130 may communicate coordinates to the seeker 102 and/or the device 104 associated with the seeker 102.

At block 628, it may be determined whether the seeker has physically entered the area. The determination may be based on locational data received from a device associated with the seeker. For example, with reference to FIGS. 1 and 4, the geocache module 130 may determine whether the seeker 102 has physically entered the area surrounded by the digital fence 404. The determination may be based on locational data received from the device 104 associated with the seeker 102. In response to a determination that the seeker has not physically entered the area (“No” at block 628), the method 600 may wait until the locational data indicates that the seeker has physically entered the area.

In response to a determination that the seeker has physically entered the area (“Yes” at block 628), the method 600 may proceed to block 630. At block 630, a message may be communicated indicating that the seeker is entitled to the second actual benefit. The message may be communicated to a device associated with the seeker in response to a determination that the seeker has physically entered the area. For example, with reference to FIGS. 1 and 4, the geocache module 130 may communicate a message to the device 104 of the seeker 102 when the seeker 102 has entered an area surrounded by the digital fence 404. At block 632, the seeker may be awarded the second actual benefit. For example, with reference to FIG. 1, the seeker 102 may be awarded with the second actual benefit by the geocache server 116.

With reference to FIG. 6D, at block 634, a virtual benefit may be identified. The virtual benefit may be provided for locating the geoseed. The virtual benefit may be configured for use in a game involving locating the geocache. The game may include virtual game actions performed through communication of digital data via a network and actual game actions performed in a real-world environment. The geocache may have placed therein an item used in the game.

At block 636, the seeker may be prompted for information included in the item. For example, with reference to FIGS. 1 and 3, the geocache module 130 and/or the game module 134 may prompt the seeker 102 for information on the clue portions 302.

At block 638, the seeker may be enabled to perform a virtual game action. The virtual game action may be based on the information included in the item. For example, with reference to FIG. 1, the game module 134 may enable the seeker 102 to perform a virtual game action in a game hosted by the game module 134.

At block 640, seeker information may be updated of the seeker to reflect the virtual benefit. In some embodiments, the seeker information may be updated in response to receiving the confirmation signal. For example, with reference to FIG. 1, the game module 134 may update the seeker information 128.

At block 642, the updated seeker information may be posted to a social network. For example, with reference to FIG. 1, the game module 134 may post the updated seeker information 128 to the social network hosted by the social media server 114.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may comprise tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method comprising:
receiving a seeker inquiry;
in response to the seeker inquiry, communicating coordinates of a geocache, the geocache including a geoseed that is sponsored by an advertiser;
identifying an actual benefit provided for locating the geoseed, wherein the actual benefit is associated with the advertiser;
receiving a confirmation signal indicating a seeker has located the geocache, the confirmation signal including verification information specific to the geoseed;
authenticating the verification information; and
awarding the seeker the actual benefit.

2. The method of claim 1, further comprising:
identifying a second actual benefit that is provided for physically entering an area surrounded by a particular digital fence configured at least partially by the advertiser;
communicating coordinates of the particular digital fence to the seeker;
determining whether the seeker has physically entered the area based on locational data received from a device associated with the seeker;
in response to a determination that the seeker has physically entered the area, communicating a message to the seeker indicating that the seeker is entitled to the second actual benefit; and
awarding the seeker the second actual benefit.

3. The method of claim 1, further comprising:
communicating a portion of seeker information and a portion of game information to the advertiser;
receiving a bid from the advertiser to sponsor the geoseed;
accepting the bid from the advertiser to sponsor the geoseed;
associating a sponsorship of the geoseed with the advertiser; and
receiving an indication of the actual benefit provided for locating of the geoseed from the advertiser.

4. The method of claim 1, further comprising communicating coordinates of the geoseed to the advertiser to enable placement of the actual benefit in the geocache.

5. The method of claim 1, further comprising identifying a virtual benefit that is provided for locating the geoseed, the virtual benefit configured for use in a game involving locating the geocache and including one or more virtual game actions performed through communication of digital data via a network and one or more actual game actions performed in a real-world environment.

6. The method of claim 5, wherein the geocache has placed therein an item used in the game, the method further comprising:
prompting the seeker for information included in the item; and
enabling the seeker to perform a virtual game action based on the information included in the item.

7. The method of claim 5, wherein the game includes an adventure in which a plurality of seekers accumulates virtual benefits and actual benefits through location of a plurality of geocaches and through performance of the virtual game actions and actual game actions.

8. The method of claim 5, further comprising in response to receiving the confirmation signal:
updating seeker information of the seeker to reflect the virtual benefit; and
posting the updated seeker information to a social network.

9. The method of claim 1, wherein the actual benefit includes one or more of a coupon, an item, a gift card, and a store credit.

10. The method of claim 1, wherein the verification information includes one or more of geoseed identifying information; a digital code; a picture of the geoseed; and redemption of the actual benefit.

11. A non-transitory computer-readable medium having encoded therein programming code executable by a processor to perform operations comprising:
communicating a portion of game information to an advertiser;
accepting a received bid from the advertiser to sponsor a geoseed or a particular digital fence;
associating a sponsorship of the geoseed or the particular digital fence with the advertiser;
in response to a seeker inquiry from a seeker, communicating coordinates of the particular digital fence or a geocache in which the geoseed is placed to a device associated the seeker;
receiving a confirmation signal indicating the seeker has located the geocache or physically entered the area, the confirmation signal including verification information;
authenticating the verification information;
following authentication of the verification information, identifying an actual benefit that is provided for physically entering the area or locating the geoseed; and
awarding the seeker the actual benefit.

12. The non-transitory computer-readable medium of claim 11, wherein the operations further comprise:
determining whether the seeker has physically entered the area based on locational data received from the device; and
in response to a determination that the seeker has physically entered the area, communicating a message to the seeker indicating that the seeker is entitled to the actual benefit.

13. The non-transitory computer-readable medium of claim 11, wherein:
the geocache has placed therein an item used in the game; and
the operations further comprise:
identifying a virtual benefit that is provided for locating the geoseed, wherein the virtual benefit is configured for use in a game involving locating the geocache and including one or more virtual game actions performed through communication of digital data via a network and one or more actual game actions performed in a real-world environment;
prompting the seeker for information included in the item; and
enabling the seeker to perform a virtual game action based on the information included in the item.

14. The non-transitory computer-readable medium of claim 13, wherein the operations further comprise updating seeker information of the seeker to reflect the virtual benefit further comprising in response to the authentication of the verification information and posting the updated seeker information to a social network.

15. A geocache server configured to operate in a geocaching/treasuring hunting environment including a device associated with a seeker and a social media server, the geocache server comprising:
an ad module configured to communicate a portion of game information to an advertiser, to accept a received bid from the advertiser to sponsor a geoseed, and to associate a sponsorship of the geoseed with the advertiser;
a geocache module configured to communicate coordinates of a geocache into which the geoseed is placed in response to a seeker inquiry, to receive a confirmation signal including verification information indicating the seeker has located the geocache, to identify an actual benefit provided by the advertiser for locating the geoseed, to identify a virtual benefit provided for locating the geoseed, and to authenticate the verification information; and
a game module configured to host a game involving locating the geocache and including one or more virtual game actions performed through communication of digital data via a network and one or more actual game actions performed in a real-world environment, wherein the virtual benefit is configured for use in the game.

16. The geocache server of claim 15, wherein the geocache module is further configured to:
identify a second actual benefit that is provided for physically entering an area surrounded by a particular digital fence configured at least partially by the advertiser;
determine whether the seeker has physically entered the area based on locational data received from a device associated with the seeker; and
in response to a determination that the seeker has physically entered the area, communicate a message to the seeker indicating that the seeker is entitled to the second actual benefit.

17. The geocache server of claim 15, wherein:
the geocache has placed therein an item used in the game; and
the game module is further configured to:
prompt the seeker for information included in the item; and
enabling the seeker to perform a virtual game action based on the information included in the item.

18. The geocache server of claim 15, wherein the game includes an adventure in which a plurality of seekers accumulates virtual benefits and actual benefits through location of a plurality of geocaches and through participation in one or more virtual games.

19. The geocache server of claim 15, wherein the game module is further configured to:
update seeker information of the seeker to reflect an awarded virtual benefit; and
post the updated seeker information to a social network hosted by a social media server.

20. The geocache server of claim 15, wherein in response to authentic verification information, the geocache module is further configured to award a seeker with the actual benefit or to provide access to the actual benefit.
